(19) United States
(12) Patent Application Publication
(10) Pub. No.: US 2020/0406884 A1
(43) Pub. Date: Dec. 31, 2020

(54) CONTROL DEVICE AND VEHICLE

(71) Applicant: HONDA MOTOR CO., LTD., Tokyo (JP)

(72) Inventors: Runa Kaneko, Wako-shi (JP); Koji Kuriyagawa, Wako-shi (JP)

(73) Assignee: HONDA MOTOR CO., LTD., Tokyo (JP)

(21) Appl. No.: 17/022,293

(22) Filed: Sep. 16, 2020

Related U.S. Application Data
(63) Continuation of application No. PCT/JP2018/011841, filed on Mar. 23, 2018.

(51) Int. Cl. B60W 10/20; B60W 40/06

(52) U.S. Cl. CPC B60W 10/20; B60W 2552/35; B60W 2422/70; B60W 40/06

(57) ABSTRACT

A present invention is a control device, that can be mounted in a vehicle including left and right wheels, comprising a detection unit for detecting, for the left and right wheels, a displacement in a vertical direction of the vehicle body, and a correction unit for correcting, based a detection result of the detection unit, a variation of a vehicle advancing direction caused by the displacement.

### CROSS-REFERENCE TO RELATED APPLICATION

This application is a continuation of International Patent Application No. PCT/JP2018/011841 filed on Mar. 23, 2018, the entire disclosure of which is incorporated herein by reference.

### TECHNICAL FIELD

The present invention mainly relates to an in-vehicle control device.

### BACKGROUND ART

In general, a vehicle including left and right wheels advances straight while traveling if the traveling distances of the left and right wheels are equal in the horizontal direction, and turns if a difference is generated between these.

### CITATION LIST

### Patent Literature

PTL 1: Japanese Patent Laid-Open No. 2012-36726

### SUMMARY OF INVENTION

### Technical Problem

During traveling, for example, if one of the left and right wheels passes over an undulation or a step, a difference may be generated in the traveling distance in the horizontal direction between these. For this reason, the actual advancing direction of the vehicle may vary from a desired direction.

It is an object of the present invention to relatively easily implement traveling control to make a vehicle advance in a desired direction.

### Solution to Problem

One aspect of the present invention relates to a control device, and the control device is a control device that can be mounted in a vehicle including left and right wheels, comprising a detection unit for detecting, for the left and right wheels, a displacement in a vertical direction of the vehicle body, based on an acceleration applied to a vehicle body; and a correction unit for correcting, based a detection result of the detection unit, a variation of a vehicle advancing direction caused by the displacement.

### Advantageous Effects of Invention

According to the present invention, it is possible to appropriately make a vehicle advance in a desired direction.

### BRIEF DESCRIPTION OF DRAWINGS

FIG. 1 is a schematic view for explaining an example of the arrangement of a working machine as a riding vehicle;

FIG. 2 is a block diagram for explaining an example of the arrangement of the working machine;

FIG. 3A is a view for explaining a traveling mode of the working machine at the time of straight advancing;

FIG. 3B is a view for explaining a traveling mode when passing over an undulation or the like on a traveling surface;

FIG. 4 is a flowchart for explaining an example of a control method for correcting a variation of the advancing direction;

FIG. 5 is a view for explaining a traveling mode when a variation of the advancing direction is corrected;

FIG. 6 is a block diagram for explaining one example of the arrangement of the working machine;

FIG. 7 is a block diagram for explaining one example of the arrangement of the working machine;

FIG. 8 is a block diagram for explaining one example of the arrangement of the working machine; and

FIG. 9 is a block diagram for explaining one example of the arrangement of the working machine.

### DESCRIPTION OF EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

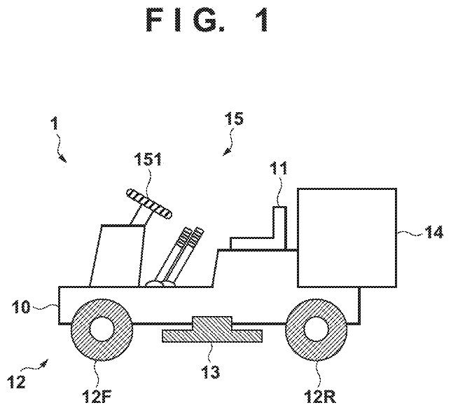

FIG. 1 shows an example of the arrangement of a working machine 1 according to the embodiment. The working machine 1 is configured to execute a work in a predetermined area. Examples of the working machine 1 are a lawn mower that performs lawn mowing, a snowplow that performs snow removing, and the like. In this embodiment, the working machine 1 is a lawn mower. In this embodiment, the working machine 1 is a riding vehicle whose vehicle body 10 is provided with a seat 11 on which an operator (occupant) can sit. However, the working machine 1 is not limited to this example, and may be, for example, an unmanned traveling vehicle. The working machine 1 includes a traveling unit 12, a working unit 13, a storage unit 14, and an operation unit 15.

The traveling unit 12 is configured to make the working machine 1 travel and provided on the lower side of the vehicle body 10 to support the vehicle body 10. In this embodiment, the working machine 1 is a four-wheel vehicle, and the traveling unit 12 includes, as driving wheels, a pair of left and right rear wheels 12R and a pair of left and right front wheels 12F. As for the rear wheels 12R, the left rear wheel will be defined as a rear wheel 12R_{L}, and the right rear wheel as a rear wheel 12R_{R}, as will be described later in detail. Additionally, as for the front wheels 12F, the left front wheel will be defined as a front wheel 12F_{L}, and the right front wheel as a front wheel 12F_{R}.

In this embodiment, the working unit 13 is a lawn mowing blade provided on the lower side of the vehicle body 10, and is provided such that the position in the vertical direction of the vehicle body with respect to the working unit 13 can be adjusted. Hence, the lawn mowing blade serving as the working unit 13 can mow a lawn in a working area to a desired height.

The storage unit 14 stores the lawn mowed by the lawn mowing blade serving as the working unit 13. The vehicle body 10 is provided with a duct (not shown) from the upper portion of the working unit 13 to the rear portion, and the mowed lawn is guided to the storage unit 14 via the duct and stored.

The operation unit 15 includes a plurality of operators configured to drive and control the traveling unit 12 and the working unit 13. As one of the operation units 15, a steering wheel 151 serving as a steering operator is shown here. In addition, an acceleration operator, a braking operator, a working operator, and the like are included. Note that as these operators, any one of a pedal method, a lever method, a switch method may be employed.

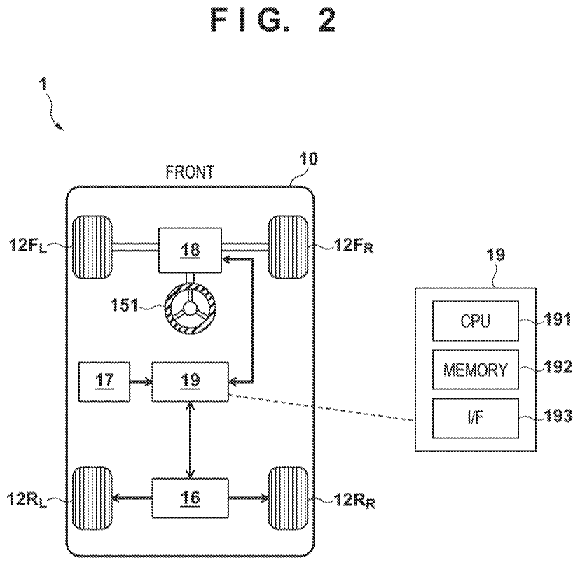

FIG. 2 is a schematic plan view for explaining other elements of the working machine 1. The working machine 1 includes a driving unit 16, a detection unit 17, a steering mechanism 18, and a control device 19.

The driving unit 16 drives the rear-side left and right wheels 12R_{L} and 12R_{R} that are driving wheels by a predetermined driving force. In this embodiment, the driving unit 16 can drive each of the rear-side left and right wheels 12R_{L} and 12R_{R} and can individually adjust (or control) the driving forces, as will be described later in detail. The driving unit 16 need only be configured to generate a predetermined power (rotation) and transmit it to the rear-side left and right wheels 12R_{L} and 12R_{R}. For example, as the driving unit 16, an electric motor and a motor driver may be used as an example, or an internal combustion engine may be used as another example. Additionally, a predetermined transmission such as an HST (hydrostatic transmission) or a CVT (continuously variable transmission) may further be used.

The detection unit 17 is configured to detect the information of the working machine 1 at the time of traveling/at the time of working, and is formed by arranging a plurality of sensors at a plurality of positions of the vehicle body 10, respectively. As the plurality of sensors, for example, a vehicle speed sensor, a G sensor, and the like can be used, and by these, the control device 19 can detect various kinds of information of the working machine 1.

In this embodiment, the steering mechanism 18 can change the directions of the front-side left and right wheels 12F_{L} and 12F_{R} that are driven wheels in accordance with the operation amount of the steering wheel 151, and can thus change the advancing direction of the working machine 1.

In this embodiment, the control device 19 is an ECU (electronic control unit), and includes a CPU (Central Processing Unit) 191, a memory 192, and an external communication interface 193. The control device 19 can control the operation of each element of the working machine 1 by the CPU 191 and the memory 192 based on, for example, the detection result of the detection unit 17. As an example, the steering mechanism 18 includes a power steering, and the control device 19 can drive and control the steering mechanism 18 based on the operation amount of the steering wheel 151, which is detected by the detection unit 17. In addition, the control device 19 can also control, for example, the driving unit 16 based on another detection result of the detection unit 17, as will be described later in detail.

Note that the control device 19 may be formed by a semiconductor device such as a PLD (Programmable Logic Device) or an ASIC (Application Specific Integrated Circuit). That is, the function of the control device 19 can be implemented by either hardware or software. In addition, the control device 19 is shown here as a single element but may be formed by two or more elements.

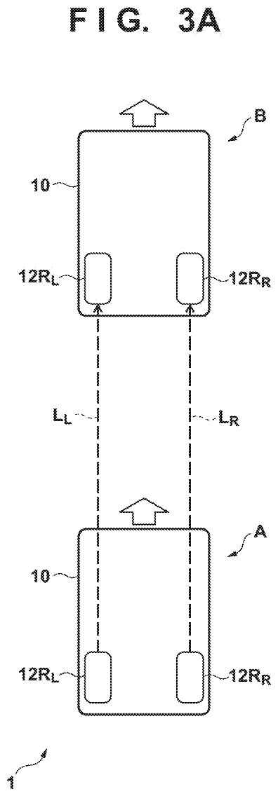

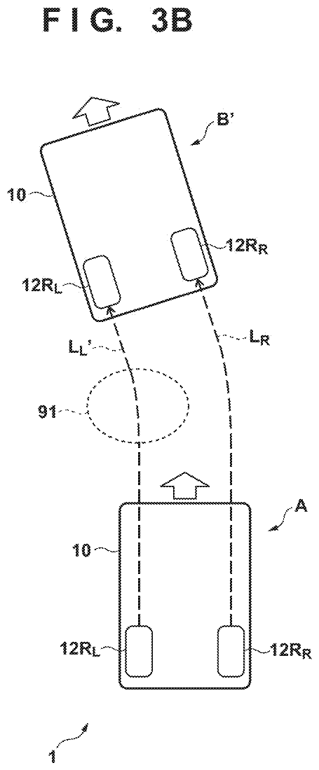

FIG. 3A shows a traveling mode of the working machine 1 at the time of straight advancing. In the example shown in FIG. 3A, a case in which an operation amount input to the steering wheel 151 does not substantially exist (a straight advancing operation is input), and the traveling surface is substantially planar (horizontal surface) is considered. Here, to make the drawing easy to see, the advancing method of the working machine 1 is indicated by arrows, and the vehicle body 10 and the rear-side left and right wheels 12R_{L} and 12R_{R} are shown as the constituent elements of the working machine 1 while the remaining elements are not illustrated.

In the example shown in FIG. 3A, the traveling distance of the left rear wheel 12R_{L} in the horizontal direction and the traveling distance of the right rear wheel 12R_{R} in the horizontal direction are equal to each other. For this reason, the working machine 1 substantially advances straight from a position A to a position B. Here, let a distance L_{L} be the distance of the left-side rear wheel 12R_{L}, and a distance L_{R} (=L_{L}) be the distance of the right-side rear wheel 12R_{R}.

FIG. 3B shows a traveling mode when the working machine 1 advancing straight passes over an undulation 91. To facilitate understanding, it is assumed here that, of the rear-side left and right wheels 12R_{L} and 12R_{R}, the right-side rear wheel 12R_{R} substantially travels on a plane, and on the way, the left-side rear wheel 12R_{L} passes over the undulation 91. In this case, the traveling distance of the right-side rear wheel 12R_{R} in the horizontal direction is the distance L_{R} (as in FIG. 3A), and the traveling distance of the left-side rear wheel 12R_{L} in the horizontal direction is a distance L_{L}′ (≠L_{L}).

Here, the working machine 1 is traveling straight, and the actual traveling distances (the numbers of rotations per unit time) of the rear-side left and right wheels 12R_{L} and 12R_{R} are equal to each other. For this reason, the actual traveling distance of the left-side rear wheel 12R_{L} is the distance L_{L} (=L_{R}), and its horizontal component is L_{L}′ described above. That is, when the left-side rear wheel 12R_{L} passes over the undulation 91, a part of the actual traveling distance L_{L} becomes a vertical component, and the horizontal component decreases accordingly. As a result, L_{L}′<L_{R}. When the working machine 1 passes over the undulation 91, a variation of the advancing direction (a left turn in the example of FIG. 3B) occurs, and the working machine 1 reaches a point B′.

Note that since the above-described variation of the advancing direction occurs depending on whether the vertical component is included in the actual traveling distance LL, the undulation 91 can be either a concave portion or a convex portion, and the variation amount of the advancing direction changes depending on the degree of the elevation difference. This also applies to a case of a step formed by a stone or the like on the road surface, in place of the undulation 91. A description will be made below while including the step in the concept of the undulation.

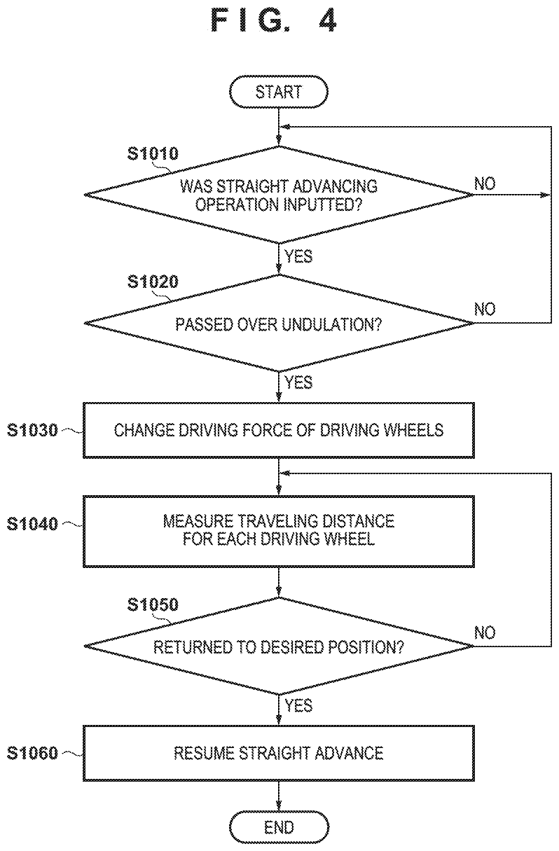

FIG. 4 is a flowchart for explaining an example of a control method for correcting the above-described variation of the advancing direction. This control method is mainly executed by the control device 19. As the outline, if it is detected that one of the left and right wheels has passed over an undulation, the driving forces of the left and right wheels are adjusted, thereby correcting the variation of the advancing direction.

In step S1010 (to be simply referred to as “S1010” hereinafter, and this also applies to the remaining steps), it is determined whether a straight advancing operation is input, S1010 is performed based on the operation amount input to the steering wheel 151. If the operation amount is substantially absent, it can be determined that a straight advancing operation is input. If the straight advancing operation is input, the process advances to S1020. Otherwise, the process returns to S1010.

In S1020, it is determined whether the working machine 1 has passed over an undulation. This determination can be implemented by detecting a displacement of each wheel 12R_{L} or the like in the vertical direction of the vehicle body using the detection unit 17. Here, to facilitate the description, it is determined whether one of the rear-side left and right wheels 12R_{L} and 12R_{R} has passed over an undulation. Here, to facilitate the description, passing of a wheel over an undulation indicates a mode after a wheel traveling on a plane enters an undulation until it travels on the plane again. For example, if the G sensor of the detection unit 17 detects a G (acceleration) in the left-and-right direction of the vehicle body (strictly speaking, if the G varies from zero and then substantially returns to zero), it can be determined that one wheel has passed over an undulation (accordingly, the advancing direction of the working machine 1 has changed). In this case, the G sensor is preferably arranged between the rear-side left and right wheels 12R_{L} and 12R_{R} or arranged near each of the rear-side left and right wheels 12R_{L} and 12R_{R}.

For example, if the left-side rear wheel 12R_{L} has passed over a convex portion, a G in the rightward direction of the vehicle body is detected, and if the left-side rear wheel 12R_{L} has passed over a concave portion, a G in the leftward direction of the vehicle body is detected. Additionally, if the right-side rear wheel 12R_{R} has passed over a convex portion, a G in the leftward direction of the vehicle body is detected, and if the right-side rear wheel 12R_{R} has passed over a concave portion, a G in the rightward direction of the vehicle body is detected.

In S1030, the driving forces of the rear-side left and right wheels 12R_{L} and 12R_{R} that are driving wheels are changed based on the determination result of S1020. More specifically, since a variation of the advancing direction has occurred due to the passing of the working machine 1 over the undulation, the working machine 1 is made to travel to correct the traveling position and return the advancing direction to the original state (that is, to implement track correction). For example, in the example of FIG. 3B, the working machine 1 makes a left turn when passing over the undulation 91. Hence, the driving force of the left-side rear wheel 12R_{L} is made large and/or the driving force of the right-side rear wheel 12R_{R} is made small such that the working machine 1 makes a right turn after the left turn and travels up to a position according to the initial advancing direction.

In S1040, the traveling distance is measured for each driving wheel. This measurement can be implemented by detecting the number of rotations of each wheel 12R_{L} or the like using the detection unit 17. For example, in the example of FIG. 3B, since the working machine 1 has passed over the undulation 91, the traveling distance L_{L}′ of the left-side rear wheel 12R_{L} has become shorter than the traveling distance L_{R} of the right-side rear wheel 12R_{R} (L_{L}′<L_{R}). For this reason, the working machine 1 is made to travel by driving the rear-side left and right wheels 12R_{L} and 12R_{R} by the driving forces changed in S1030 until the difference is compensated for. In this case, the traveling distance measured in S1040 is the traveling distance in the horizontal direction.

In S1050, it is determined whether the working machine 1 has returned to the desired position (whether the working machine 1 has traveled up to the position according to the initial advancing direction). This determination is performed based on the measurement result of S1040. For example, in the example of FIG. 3B, the determination is performed based on whether the difference between the traveling distance L_{L}′ of the left-side rear wheel 12R_{L} and the traveling distance L_{R} of the right-side rear wheel 12R_{R} is compensated for. If the working machine 1 has returned to the desired position, assuming that the above-described correction of the variation of the advancing direction is completed, the process advances to S1060. Otherwise, the process returns to S1040.

In S1060, assuming that the above-described correction of the variation of the advancing direction is completed, straight advancing is resumed along the initial advancing direction. This can be implemented using, for example, a known self-position estimation method based on the detection results of various kinds of sensors of the detection unit 17. As an example, the working machine 1 travels while temporarily storing data representing the advancing direction in a predetermined memory. In S1060, steering is performed based on the data and the G sensor in the direction according to the advancing direction before S1020, thereby adjusting the posture of the working machine 1. Alternatively, as another example, a turning angle necessary for the working machine 1 to direct in the initial advancing direction when reaching the desired position can be calculated using, for example, odometry.

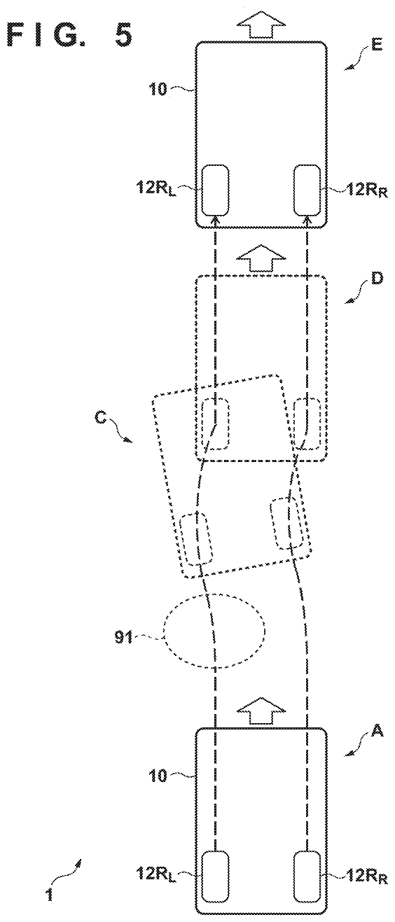

FIG. 5 shows a traveling mode of the working machine 1 according to the control method shown in FIG. 4, as in FIGS. 3A and 3B. At a point C after the working machine 1 has passed over the undulation 91 with the left-side rear wheel 12R_{L} and made a left turn (after S1020), the driving force of the left-side rear wheel 12R_{L} is made larger than the driving force of the right-side rear wheel 12R_{R} (S1030), and the working machine 1 thus makes a right turn. After that, after determining, based on the measurement result of the traveling distance for each of the rear-side left and right wheels 12R_{L} and 12R_{R}, that the working machine 1 has reached a point D according to the initial advancing direction (S1040 and S1050), straight advancing according to the initial advancing direction is resumed (S1060). The working machine 1 can thus reach a point E advanced from the point A in the initial advancing direction.

Note that here, correction of the variation of the advancing direction is completed at the point D, and straight advancing is then resumed. However, a process of finely adjusting the advancing direction may further be performed.

In this embodiment, the correction is started after the working machine 1 has passed over the undulation 91. However, the correction may be started during passing over the undulation 91. For example, the correction may be performed twice, that is after entry to the undulation 91 and after passing over the undulation 91. Additionally, for example, if the undulation 91 is formed by a plurality of unevennesses, the correction may continuously be executed based on a G generated by each of the plurality of unevennesses. Alternatively, if the undulation 91 has uneven tilt angles, the correction may continuously be executed based on a G that changes over time. When the correction is executed a plurality of times during passing over the undulation 91, the working machine 1 can substantially advance straight while passing over the undulation 91. In this case, S1040 to S1060 may be omitted.

In FIGS. 4 and 5, to simplify the description, in S1020 (see FIG. 4), it is determined whether one of the rear-side left and right wheels 12R_{L} and 12R_{R} has passed over the undulation. However, the above-described variation of the advancing direction may occur even in a case in which both the rear-side left and right wheels 12R_{L} and 12R_{R} have passed over undulations with height differences different from each other. For example, if the left-side rear wheel 12R_{L} has passed over a relatively large concave portion, and the right-side rear wheel 12R_{R} has passed over a relatively small concave portion (G in the leftward direction of the vehicle body is generated during this), the working machine 1 makes a left turn. Hence, in S1020, the displacement in the vertical direction of the vehicle body for each of the rear-side left and right wheels 12R_{L} and 12R_{R} is detected based on the G in the left-and-right direction of the vehicle body, and it is determined whether these have passed over undulations.

If both the rear-side left and right wheels 12R_{L} and 12R_{R} have passed over concave portions of almost the same height differences (G in the left-and-right direction of the vehicle body is not substantially generated during this), the above-described variation of the advancing direction does not substantially occur. In this case, it can be detected, based on the G in the left-and-right direction of the vehicle body, that the variation of the advancing direction has not occurred.

On the other hand, if the left-side rear wheel 12R_{L} has passed over a concave portion, and the right-side rear wheel 12R_{R} has passed over a convex portion of almost the same height difference as the concave portion, a G in the leftward direction of the vehicle body is generated during this, but the above-described variation of the advancing direction does not substantially occur. In this case, the left side of the vehicle body lowers, and the right side of the vehicle body rises, resulting in rolling. At this time, the axis of the rolling is substantially located at the center of the axle that connects the rear-side left and right wheels 12R_{L} and 12R_{R}. On the other hand, if the left-side rear wheel 12R_{L} has passed over a concave portion, and the right-side rear wheel 12R_{R} has passed over a convex portion having a height difference different from the concave portion (in this case, a variation of the advancing direction occurs), the axis of the rolling of the vehicle body 10 is not located at the center of the axle. Hence, even if one of the rear-side left and right wheels 12R_{L} and 12R_{R} passes over a concave portion, and the other passes over a convex portion, the variation of the advancing direction can be detected based on the G generated in the left-and-right direction of the vehicle body.

Note that the above description also applies to the front-side left and right wheels 12F_{L} and 12F_{R}. That is, the determination of S1020 may be done based on whether the front-side left and right wheels 12F_{L} and 12F_{R} have passed an undulation. If the plurality of left and right wheels are provided while being apart in the vehicle longitudinal direction, the determination may be done for any left and right wheels of these.

The flowchart of FIG. 4 is merely a mode configured to correct the variation of the advancing direction. Some steps may be omitted, or other steps may be inserted in accordance with the purpose or the like. For example, since the variation of the advancing direction may occur even during a turn, S1010 can be omitted. If a variation has occurred in the advancing direction in turning due to passing over a predetermined undulation during the turn (S1020), the driving forces of the front-side left and right wheels 12F_{L} and 12F_{R} are changed to correct the variation. In this case, after S1050, turning in the direction according to the operation amount input to the steering wheel 151 is resumed in place of S1060.

In addition, the variation of the advancing direction caused by passing over an undulation can also occur during traveling on a tilting surface. For example, on a tilting surface whose tilt angle is substantially even, a predetermined G is applied to the vehicle body 10. In this case as well, in S1020, the variation of the advancing direction can be detected based on the G generated in the left-and-right direction of the vehicle body. If the working machine 1 has passed over an undulation on such a tilting surface, the G applied to the vehicle body 10 changes in a relatively short time. Hence, in S1020, the displacement in the vertical direction of the vehicle body for each of the rear-side left and right wheels 12R_{L} and 12R_{R} is detected based on the change amount of the G (differential value ΔG), thereby determining that the working machine 1 has passed over the undulation, regardless of a plane or a tilting surface.

As described above, in this embodiment, the control device 19 detects the displacement in the vertical direction of the vehicle body for the wheel 12R_{L} or the like (S1020), and corrects, based on the detection result, the variation of the advancing direction of the vehicle caused by the displacement (S1030). According to this embodiment, it is possible to adjust or correct the traveling path based on the displacement in the left-and-right direction of the vehicle body for the wheel 12R_{L} or the like and correct the track. For example, it is possible to correct the variation of the advancing direction, which can occur when passing over an undulation of the traveling surface, and relatively easily return the varied advancing direction to the desired direction.

In this embodiment, a mode in which the driving forces of the rear-side left and right wheels 12R_{L} and 12R_{R} that are driving wheels are individually adjusted to perform the correction has been exemplified. In place of this mode, the correction may be performed by controlling the steering mechanism 151. It can be said that in a certain viewpoint, driving support for assisting a steering operation is performed by the control device 19.

[First Example]

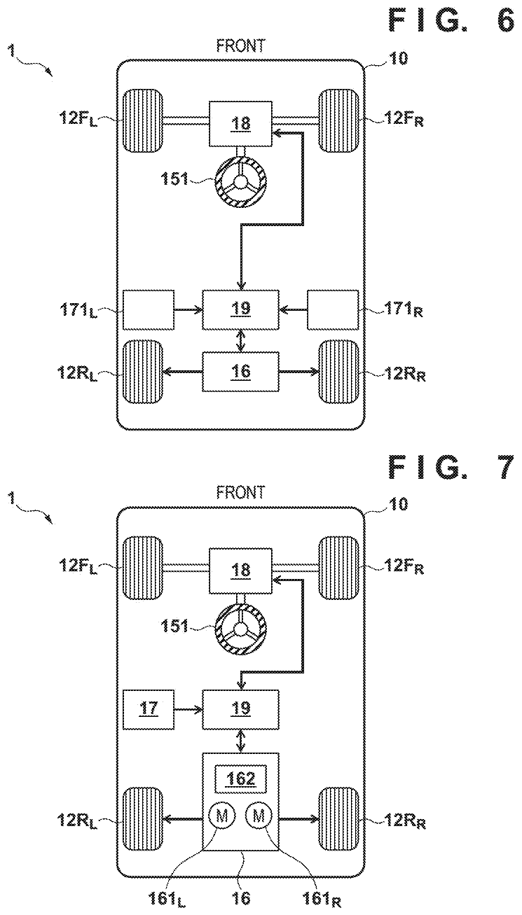

FIG. 6 shows an example of the arrangement of a working machine 1 according to the first example. In this example, as detection units 17, a pair of G sensors 171_{L} and 171_{R} are arranged on the left and right sides of a vehicle body 10, respectively. The G sensor 171_{L} is arranged on the left side of the vehicle body 10, and detects a G at the arrangement position. The G sensor 171_{R} is arranged on the right side of the vehicle body 10, and detects a G at the arrangement position.

According to this embodiment, it is possible to appropriately and relatively easily detect the displacement in the vertical direction of the vehicle body for each of left and right wheels 12R_{L} and 12R_{R} based on the detection results of the pair of G sensors 171_{L} and 171_{R}. If a variation occurs in the advancing direction due to the displacement of one/both of the left and right wheels 12R_{L} and 12R_{R}, this can appropriately be detected.

The pair of G sensors 171_{L} and 171_{R} are preferably attached on the periphery of the rear-side left and right wheels 12R_{L} and 12R_{R}, but may be attached on the periphery of front-side left and right wheels 12F_{L} and 12F_{R}.

[Second Example]

FIG. 7 shows an example of the arrangement of a working machine 1 according to the second example. In this example, a driving unit 16 includes electric motors 161_{L} and 161_{R} and a motor driver 162. The electric motor 161_{L} drives a left-side rear wheel 12R_{L}. The electric motor 161_{R} drives a right-side rear wheel 12R_{R}. The motor driver 162 can individually drive and control the electric motors 161_{L} and 161_{R} and individually adjust the driving forces of the rear-side left and right wheels 12R_{L} and 12R_{R} by the electric motors 161_{L} and 161_{R}. According to this embodiment, it is possible to individually adjust the driving forces of the rear-side left and right wheels 12R_{L} and 12R_{R} by the relatively simple arrangement and appropriately correct a variation of the advancing direction.

As the electric motors 161_{L} and 161_{R}, for example, a typical motor such as a three-phase induction motor is preferably used. As the motor driver, a PCU (Power Control Unit) or a PDU (Power Drive Unit), which can supply power from a battery (not shown) to each of the electric motors 161_{L} and 161_{R}, is preferably used. Additionally, a controller capable of controlling the driving forces of the electric motors 161_{L} and 161_{R} in accordance with their load torques may be provided.

[Third Example]

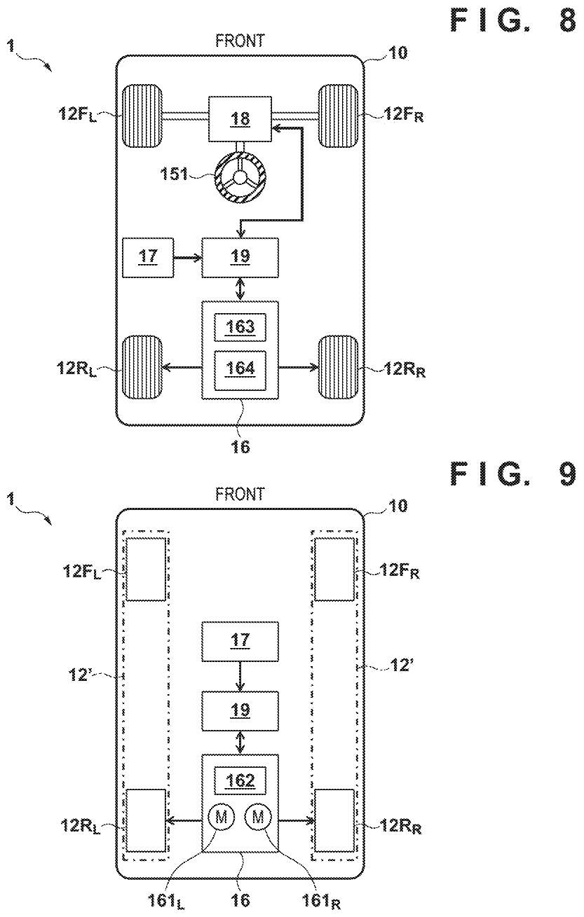

FIG. 8 shows an example of the arrangement of a working machine 1 according to the third example. In this example, a driving unit 16 includes a power source 163 and a power dividing mechanism 164. The power source 163 may be an electric motor or an internal combustion engine. The power dividing mechanism 164 divides and transmits the power generated by the power source 163 to left and right wheels 12R_{L} and 12R_{R}. The power dividing mechanism 164 is preferably configured to individually adjust the transmission efficiency to the left and right wheels 12R_{L} and 12R_{R}. Alternatively, a transmission such as a CVT or an HST may be arranged between each of the left and right wheels 12R_{L} and 12R_{R} and the power dividing mechanism 164. According to this embodiment, even if the number of power sources 163 is one, the driving forces of the rear-side left and right wheels 12R_{L} and 12R_{R} can individually be adjusted, and a variation of the advancing direction can appropriately be corrected.

[Fourth Example]

FIG. 9 shows an example of the arrangement of a working machine 1 according to the fourth example. This example is different from the above-described second example in that the working machine 1 includes a crawler traveling body in place of a traveling unit 12 that implements four-wheel traveling. That is, on the left side of a vehicle body 10, one crawler 12′ is annularly provided on a rear wheel 12R_{L} that is a driving wheel and a front wheel 12F_{L} that is a driven wheel. On the right side of the vehicle body 10, another crawler 12′ is annularly provided on a rear wheel 12R_{R} that is a driving wheel and a front wheel 12F_{R} that is a driven wheel. In this arrangement, as in the second example, the driving forces of the rear-side left and right wheels 12R_{L} and 12R_{R} can individually be adjusted, and a variation of the advancing direction can thus be appropriately corrected.

[Other Embodiments]

Several preferred modes according to the present invention have been exemplified above. However, the present invention is not limited to the examples of these modes and may partially be modified without departing from the scope of the invention. For example, other elements may be combined with the contents of each embodiment in accordance with the object, application purpose, and the like, and the contents of a certain embodiment may be combined with part of the contents of another embodiment. In addition, individual terms described in this specification are merely used for the purpose of explaining the present invention, and the present invention is not limited to the strict meanings of the terms and can also incorporate their equivalents.

For example, in the above-described embodiment, the working machine 1 has been exemplified as a lawn mower. However, the contents of the embodiment can also be applied to a snowplow including a snow removing auger as the working unit 13, or can also be applied to a farming machine such as a cultivator. Additionally, for example, in the embodiment, a riding vehicle has been exemplified as the working machine 1. However, the contents of the embodiment are the same for a straddle type vehicle.

In addition, as the arrangement of the working machine 1, an arrangement of rear wheel driving has been exemplified in the embodiment. As another embodiment, front wheel driving may be used. In the embodiment, a four-wheel vehicle has been exemplified as the working machine 1. However, the number of wheels may be not four but, for example, three (a vehicle with one front wheel and two rear wheels or two front wheels and one rear wheel).

[Summary of Embodiment]

The first aspect relates to an in-vehicle control device, and the control device is a control device (for example, 19) that can be mounted in a vehicle (for example, 1) including left and right wheels (for example, 12R_{L}, 12R_{R}), comprising a detection unit (for example, 17, S1020) for detecting, for the left and right wheels, a displacement in a vertical direction of the vehicle body, and a correction unit (for example, S1030) for correcting, based a detection result of the detection unit, a variation of a vehicle advancing direction caused by the displacement.

According to the first aspect, it is possible to correct the variation of the advancing direction of the vehicle, which can occur when passing over an undulation (a concave portion, a convex portion, a step, or the like) of a traveling surface, and relatively easily return the varied advancing direction to the desired direction.

In the second aspect, the detection unit detects the displacement based on an acceleration (G) applied to a vehicle body (for example, 10).

According to the second aspect, it is possible to appropriately detect the displacement of the left and right wheels in the vertical direction of the vehicle body.

In the third aspect, the detection unit detects the displacement based on a change amount (ΔG) of the acceleration applied to the vehicle body (for example, 10).

According to the third aspect, for example, even when traveling on a tilting surface, it is possible to appropriately detect the displacement of the left and right wheels in the vertical direction of the vehicle body and make the vehicle advance in a desired direction.

In the fourth aspect, the detection unit detects the displacement based on an acceleration in a left-and-right direction of the vehicle body.

According to the fourth aspect, it is possible to appropriately detect the displacement of the left and right wheels in the vertical direction of the vehicle body.

In the fifth aspect, the detection unit individually detects an acceleration generated on a left side of the vehicle body and an acceleration generated on a right side of the vehicle body, and detects the displacement based on the detection results.

According to the fifth aspect, it is possible to relatively easily detect, for each of the left and right wheels, the displacement in the vertical direction of the vehicle body.

In the sixth aspect, the control device further comprises a measurement unit (for example, 17, S1040) for measuring a traveling distance of each of the left and right wheels, and a determination unit (for example, S1050) for determining, based on a measurement result of the measurement unit, whether the correction by the correction unit is completed.

According to the sixth aspect, since it can be determined, based on the traveling distance of each of the left and right wheels, whether the vehicle has returned to a predetermined position, it is possible to complete the above-described correction.

The seventh aspect relates to a vehicle, and the vehicle comprises the above-described control device (for example, 19), and the left and right wheels.

According to the seventh aspect, the above-described control device can be applied to a general/typical vehicle (for example, a four-wheel vehicle).

In the eighth aspect, the vehicle further comprises a driving unit (for example, 16, 161_{L}, 161_{R}, 164) capable of individually driving the left and right wheels, wherein the correction unit performs the correction by causing the driving unit to individually drive the left and right wheels.

According to the eighth aspect, straight advancing, left turn, and right turn of the vehicle can appropriately be executed by individually driving the left and light wheels, and the varied advancing direction can be returned to a desired direction.

In the ninth aspect, the vehicle further comprises a steering operator (for example, 151), wherein the correction unit performs the correction by controlling the steering mechanism.

According to the ninth aspect, the above-described control device can suitably be applied to the vehicle (typically, a riding vehicle) including the steering operator, and in this arrangement, the varied advancing direction can be returned to the desired direction.

In the 10th aspect, the vehicle further comprises a steering operator (for example, 151), wherein the correction unit performs the correction if the displacement is detected by the detection unit although an occupant performs a straight advancing operation by the steering operator (for example, S1010).

According to the 10th aspect, if the vehicle passes over the above-described undulation, and the advancing direction of the vehicle varies, although a turning operation is not substantially input, it is possible to return the varied advancing direction to the original state and appropriately make the vehicle advance straight.

In the 11th aspect, the vehicle comprises the left and right wheels as driving wheels, and comprises a driven wheel spaced apart from the driving wheels in a longitudinal direction of the vehicle body, and a steering operator configured to steer the driven wheel.

According to the 11th aspect, in a riding vehicle of a rear wheel driving type, the above-described traveling control can be implemented by a relatively simple arrangement.

In the 12th aspect, the vehicle is a working machine (for example, 1) including a working unit (for example, 13).

According to the 12th aspect, the above-described control device can suitably be applied to a working machine assumed to travel at a relatively low speed. Examples of the working machine are a lawn mower including a lawn mowing blade as a working unit, a snowplow including a snow removing auger as the working unit. In addition, the above-described control device can also be applied to a farming machine such as a cultivator.

The present invention is not limited to the above embodiments and various changes and modifications can be made within the spirit and scope of the present invention. Therefore, to apprise the public of the scope of the present invention, the following claims are made.

1. A control device that can be mounted in a vehicle including left and right wheels, comprising:
a detection unit for detecting, for the left and right wheels, a displacement in a vertical direction of the vehicle body, based on an acceleration applied to a vehicle body; and
a correction unit for correcting, based a detection result of the detection unit, a variation of a vehicle advancing direction caused by the displacement.

2. The control device according to claim 1, wherein the detection unit detects the displacement based on a change amount of the acceleration in a left-and-right direction of the vehicle body.

3. The control device according to claim 1, wherein the detection unit individually detects a change amount of the acceleration generated on a left side of the vehicle body and a change amount of the acceleration generated on a right side of the vehicle body, and detects the displacement based on the detection results.

4. The control device according to claim 1, further comprising:
a measurement unit for measuring a traveling distance from a predetermined position of each of the left and right wheels; and
a determination unit for determining, based on a measurement result of the measurement unit, whether the correction by the correction unit is completed.

5. The control device according to claim 1, wherein
the detection unit detects the vehicle passing over an undulation of a traveling surface, based on the change amount of the acceleration, and
the correction unit executes the correction after the vehicle passes over the undulation.

6. The control device according to claim 5, wherein
the correction unit further executes the correction after entry to the undulation and before passing over the undulation.

7. The control device according to claim 1, wherein
the detection unit detects the vehicle passing over an undulation of a traveling surface, based on the change amount of the acceleration, and
the correction unit executes the correction a plurality of times during passing over the undulation.

8. A vehicle comprising:
a control device of claim 1; and
the left and right wheels.

9. The vehicle according to claim 8, further comprising a driving unit capable of individually driving the left and right wheels,
wherein the correction unit performs the correction by causing the driving unit to individually drive the left and right wheels.

10. The vehicle according to claim 8, further comprising a steering operator,
wherein the correction unit performs the correction by controlling the steering operator.

11. The vehicle according to claim 8, further comprising a steering operator,
wherein the correction unit performs the correction if the displacement is detected by the detection unit although an occupant performs a straight advancing operation by the steering operator.

12. The vehicle according to claim 8, wherein the vehicle comprises the left and right wheels as driving wheels, and comprises a driven wheel spaced apart from the driving wheels in a longitudinal direction of the vehicle body, and a steering operator configured to steer the driven wheel.

13. The vehicle according to claim 8, wherein the vehicle is a working machine including a working unit.
